(19) United States
(12) Patent Application Publication
(10) Pub. No.: US 2006/0238494 A1
(43) Pub. Date: Oct. 26, 2006

(54) Flexible displays as an input device

(75) Inventors: Chandrasekhar Narayanaswami, Wilton, CT (US); Mandayam Thondanur Raqhunath, Fishkill, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/112,952

(22) Filed: Apr. 22, 2005

(51) Int. Cl. G09G 5/00

(52) U.S. Cl. 345/156

(57) ABSTRACT

A display comprising: (a) a flexible surface operable to exhibit images, the aforesaid flexible surface being capable of exhibiting variable degrees of bend; (b) a plurality of bend sensors for creating a plurality of bend measurements from a line of bend; and (c) a line detection device operable to detect orientation and position of the aforesaid line of bend based on the aforesaid plurality of bend measurements.

### FIELD OF THE INVENTION

The present invention relates to input and display devices for computer systems.

### BACKGROUND OF THE INVENTION

Mobile devices typically have limited space and small screens. They have room for only a few buttons. In order to provide a larger screen size, a device designer is often required to further limit the size or number of control elements simply because the smaller sizes that have permitted mobile devices to be mobile, also tend to restrict the amount of surface space that can be used for display or control. Advances in display technology have made it feasible to construct displays that can be flexed to conform to non-planar surfaces or folded to facilitate more compact storage. At present, OLED displays are being prototyped on flexible substrates by Universal Displays, University of Arizona Optical Sciences Center, Philips Research, Dupont, Army Research Labs, other members of the US Display Consortium, etc. It is envisioned that unrolling or unfolding flexible displays may reduce the requirement for small or light devices to necessarily have small displays, but device output is only one part of the user-interface problem. An additional concern relates to user input and control.

Previous efforts to address the problem of user input on compact devices have typically involved attaching larger devices to the compact device or projecting a virtual display onto a flat surface. Numerous companies (including Think Outside, Inc., of Santa Clara, Calif.) produce keyboards that can be attached to compact devices such as hand held computers and mobile phones in order to provide a large (comfortable) input mechanism. However, the size of such external input mechanisms can minimize the advantage provided by the size of the easily carried compact device. Other companies (including Virtual Devices, Inc., of Allison Park, Pa.) have taken the approach of projecting an interface onto a large flat surface and detecting user interaction with this projected interface. This latter approach potentially address the issue of device size, but adds a usage constraint, requiring the availability of a large flat surface.

One solution to the general problem of limited space for display and user input is to provide mechanisms for control on the display itself. Handheld devices (such as those manufactured by palmOne Inc. of Milpitas, Calif.) and tablet devices (such as those manufactured by Wacom Technology Corporation of Vancouver, Wash.) often employ this strategy by providing stylus control for directly interacting with displayed information. Another mode of direct manipulation has been suggested where action results from a user bending the display (as suggested by Sony Incorporated, based in Tokyo, Japan). However, the simple modes of direct manipulation mentioned above all have drawbacks. The single-sensor flexible display lacks the ability to detect the richness of the user interaction with the display because it is only capable of measuring one kind of bend. Similarly, touchscreen displays typically do not detect the richness of the user interaction (instead capturing only a location expressed in X and Y coordinates). Where a tablet and stylus is used in combination to achieve greater levels of control, the stylus becomes yet another component which can be misplaced or damaged. Thus, there is a desire for displays which are capable of accepting rich user input without having the drawbacks of existing devices.

### SUMMARY OF THE INVENTION

The invention broadly and generally provides a display comprising: (a) a flexible surface operable to exhibit images, the aforesaid flexible surface being capable of exhibiting variable degrees of bend; (b) a plurality of bend sensors for creating a plurality of bend measurements from a line of bend; and (c) a line detection device operable to detect orientation and position of the aforesaid line of bend based on the aforesaid plurality of bend measurements.

In an exemplary embodiment, at least one of the aforesaid bend sensors comprises a strain gauge such as a peizo-electric bimorph or a fiber-optic curvature sensors.

In an exemplary embodiment, the aforesaid bend sensors are layered on the display in various directions. In other exemplary embodiments, bend sensors may be distributed according to a pattern on the surface or along the edges of the aforesaid display.

In an exemplary embodiment, the display comprises a touch sensor operable to detect contact to the aforesaid flexible surface.

In an exemplary embodiment, the flexible surface comprises at least one organic light emitting diode. In other exemplary embodiments, the flexible surface comprises at least one liquid crystal display element.

In an exemplary embodiment, the aforesaid display comprises multiple flexible surfaces, each operable to exhibit images.

In an exemplary embodiment, the aforesaid display comprises a controller operable, when activated, to manipulate an element of the aforesaid image, the aforesaid line detecting device being operable to activate the aforesaid controller. In an exemplary embodiment, the aforesaid element of the aforesaid image comprises a scroll bar.

The invention further broadly and generally provides a method of controlling the information presented on a display, the aforesaid display comprising: (1) a flexible surface operable to exhibit images, the aforesaid flexible surface being capable of exhibiting variable degrees of bend; (2) a plurality of bend sensors for creating a plurality of bend measurements from a line of bend; and (3) a line detection device operable to detect orientation and position of the aforesaid line of bend based on the aforesaid plurality of bend measurements, the aforesaid method comprising the steps of: (a) obtaining the orientation and position of a line of bend present on the aforesaid flexible surface; and (b) making a change to the information displayed by the aforesaid display in response to the orientation and position of the aforesaid line of bend present on the aforesaid flexible surface.

In an exemplary embodiment, the aforesaid line of bend orientation and position are used to control at least one graphical user interface element, such as a scroll bar or a cursor.

In an exemplary embodiment, the aforesaid step of obtaining the orientation and position of a line of bend present on the aforesaid flexible surface is performed twice in order to obtain a first position, a first orientation, a second position, and a second orientation; and the aforesaid step of making a change to the information displayed by the aforesaid display in response to line of bend position, orientation, and changes thereto as determined by computing the difference between first and second values.

The invention further broadly and generally provides a method for controlling a display comprising a first line of bend, the aforesaid method comprising: (a) creating a first position measurement of the position of the aforesaid first line of bend; and (b) creating a first orientation measurement of the orientation of the aforesaid first line of bend.

In an exemplary embodiment, the method further comprises mapping a combination of at least the aforesaid first position measurement and the aforesaid second orientation measurement to a controller function.

In an exemplary embodiment, the method further comprises: creating a second position measurement of a second line of bend; creating a second orientation measurement of a second line of bend; and mapping a combination of at least the aforesaid first position measurement, the aforesaid second position measurement, the aforesaid first orientation measurement, and the aforesaid second orientation measurement to a controller function.

### BRIEF DESCRIPTION OF THE DRAWINGS

FIG. 1a shows a display in accordance with the claimed invention in which a flexible surface displaying an image is attached to a rigid line detector and controller.

FIG. 1b shows a the display of FIG. 1a to depict one possible arrangment of piezo-electric bimorph sensors.

FIG. 1c shows the flexible surface of a display in accordance with the claimed invention. A line of bend is visible.

FIG. 2a shows the flexible surface of a flexible display in which strain gauge bend sensors are arranged in layers, each layer having a different sensor alignment in order to detect different positions and orientations of a line of bend. The resulting criss-cross patern is displayed.

FIG. 2b shows the flexible surface of a flexible display in which strain gauge bend sensors are distributed along the edges of the flexible surface in order to detect different positions and orientations of a line of bend.

FIG. 2c shows the flexible surface of a flexible display in which small strain gauge bend sensors distributed upon the flexible surface of the flexible display in order to detect different positions and orientations of a line of bend.

FIG. 3a shows 4 bend sensor layers labeled L1-L4 wherein sensors are arranged in different orientations. These layers are overlapped to form the sensor arrangement shown in FIG. 2a.

FIG. 3b shows layers L1 and L2 of the display in FIG. 3a to show that a line of bend will change the bend sensors which are arranged perpendicular to line of bend will be activated upon the display.

FIG. 4a shows a display in accordance with the current invention both before and after user manipulation to select subsequent items from a list appearing on the display.

FIG. 4b shows a display in accordance with the current invention both before and after user manipulation to select previous items from a list appearing on the display.

FIG. 5 shows two strain gauge bend sensors where one expresses a bend of approximately 20 degrees and the other expresses a bend of approximately 60 degrees. Here, degrees of bend are measured at the two ends of the sensor and are relative to the sensor in its normal flattened state.

### DETAILED DESCRIPTION OF PREFERRED EMBODIMENT

As will be understood the present application discloses the use of a flexible display as an input device. An exemplary display may be constructed by providing sensors to measure the amount of bend found exhibited by a display composed of electronic ink or organic light emitting diodes. Strain gauges can be used to detect bends in the display. Different types of bend sensors may even be used in combination if so desired. In one embodiment, the bend of the display can be measured by peizo-electric bimorphs, which can increase or decrease voltage depending on the degree of bend. Because only the sensors longitudinally perpendicular to the line of bend will change values, an array of peizo-electric bimorphs strategically distributed within the flexible surface of the display will indicate where the bend is located and how the bend is oriented.

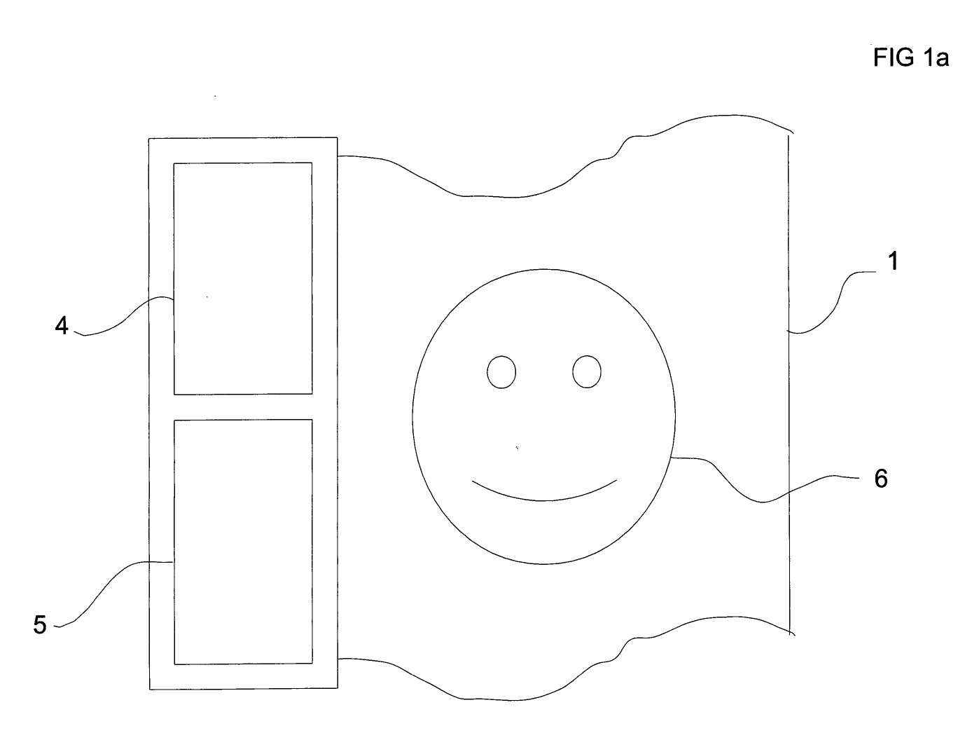

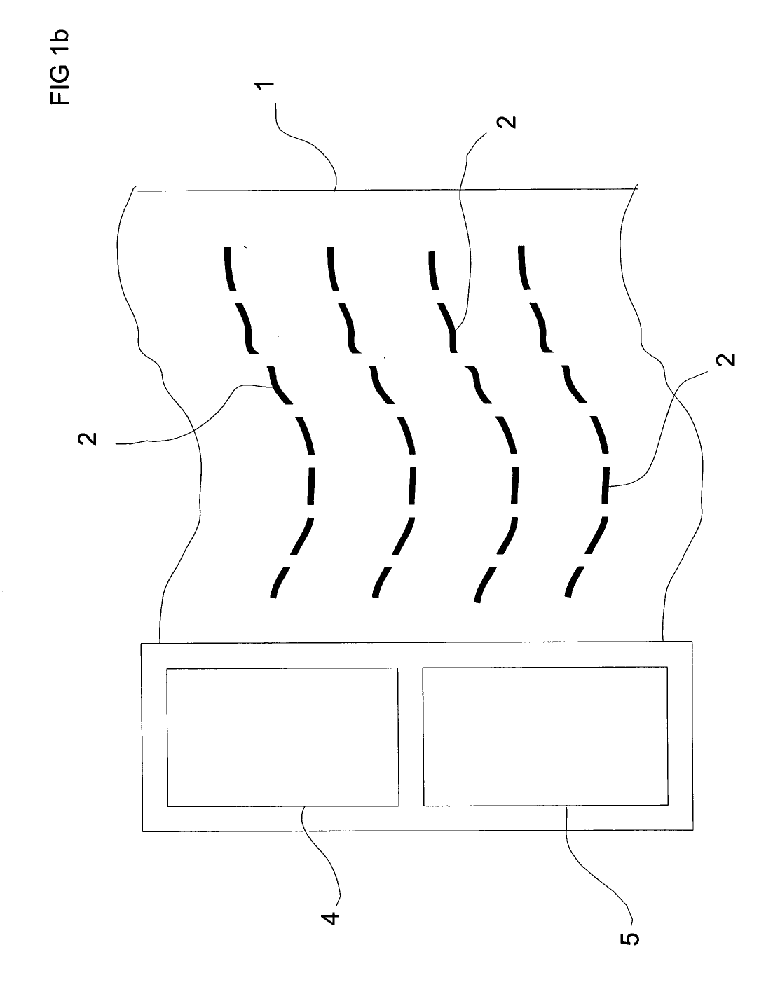

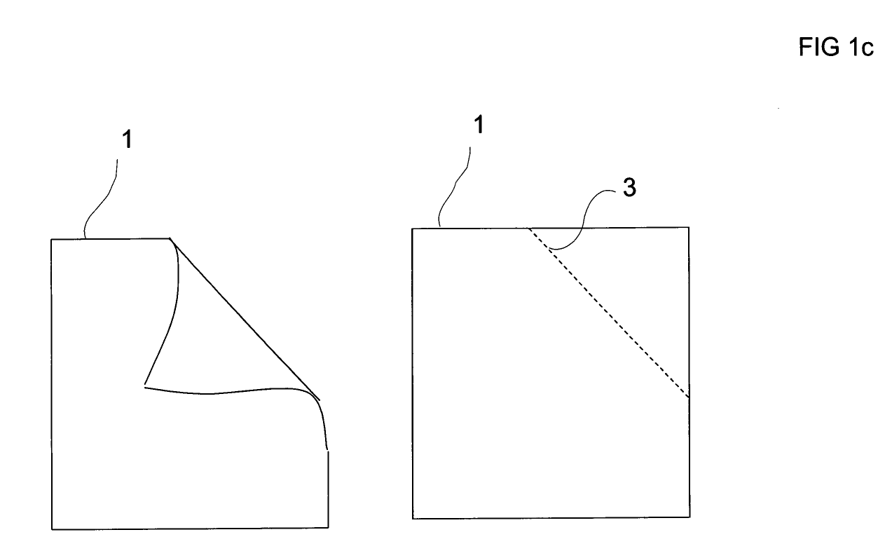

FIG. 1a shows one display according to the current invention. The display shown has a flexible surface 1 which exhibits the image of a face 6. The image in the example shown is generated by OLEDs, which cover the flexible surface and hide an array of peizo-electric bimorph bend sensors 2 which are shown in FIG. 1b. The bend sensors 2 provide a plurality of bend measurements which are used by a line detection device 4 in order to detect the orienation and position of lines of bend 3 (as shown in FIG. 1c) which may be present on the flexible surface of the display. The detected lines are used as user input by a display controller 5 which makes changes to the image 6 when warranted by the input within the context of some application. FIG. 1c shows that a deformation in the flexible surface 1 of a display in accordance with the present invention can generate a line of bend 3. As will be understood, the line of bend 3 can be obtained in a number of ways.

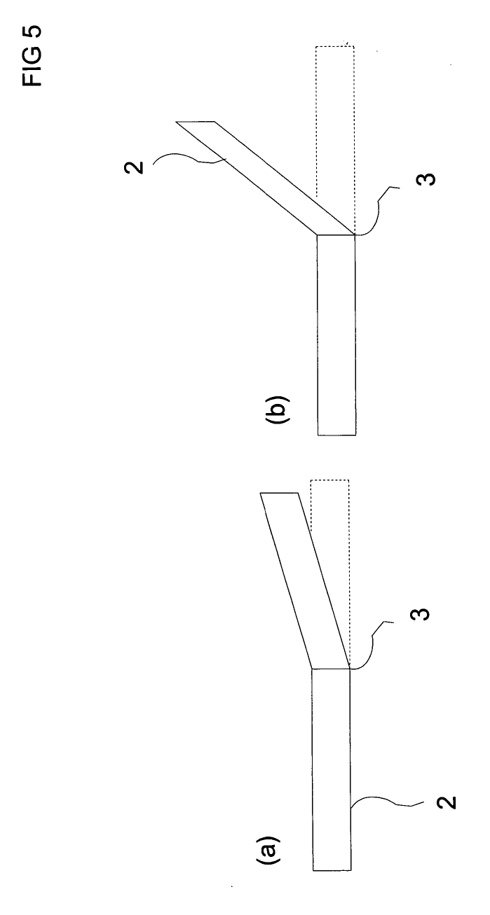

FIG. 5 shows two strain gauge bend sensors 2, identical but for different degrees of bend. One sensor 2 (a) is shown bent at approximately 20 degrees measured from the ends of the sensor. The other sensor 2 (b) is shown bent at approximately 60 degrees. These sensors will provide different values to the line detection device 4, which may distinguish between these degrees of bend to determine where lines of bend may be expressed on the flexible surface 1. A line detection device 4 in accordance with the present invention may determine position, orientation, and degree of bend for lines present on the flexible surface 1 with the level of precision and in a manner appropriate for the number and arrangement of sensors 2 on the flexible surface 1.

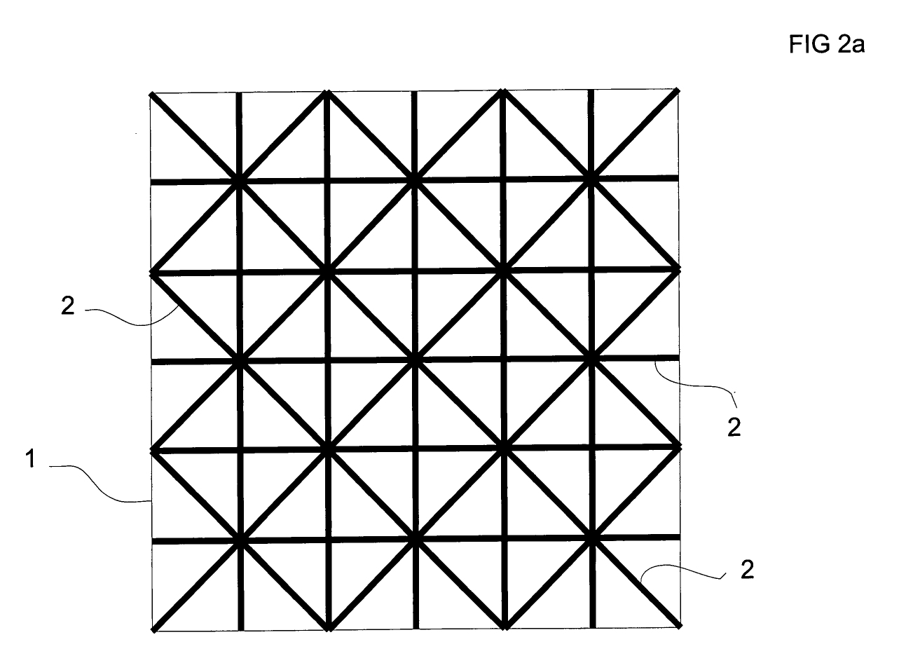

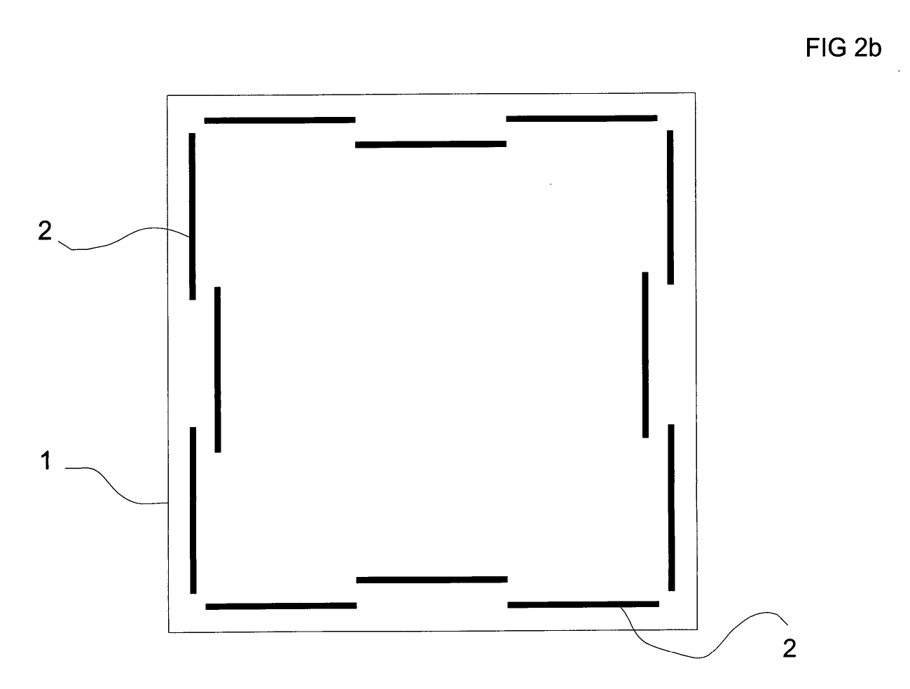

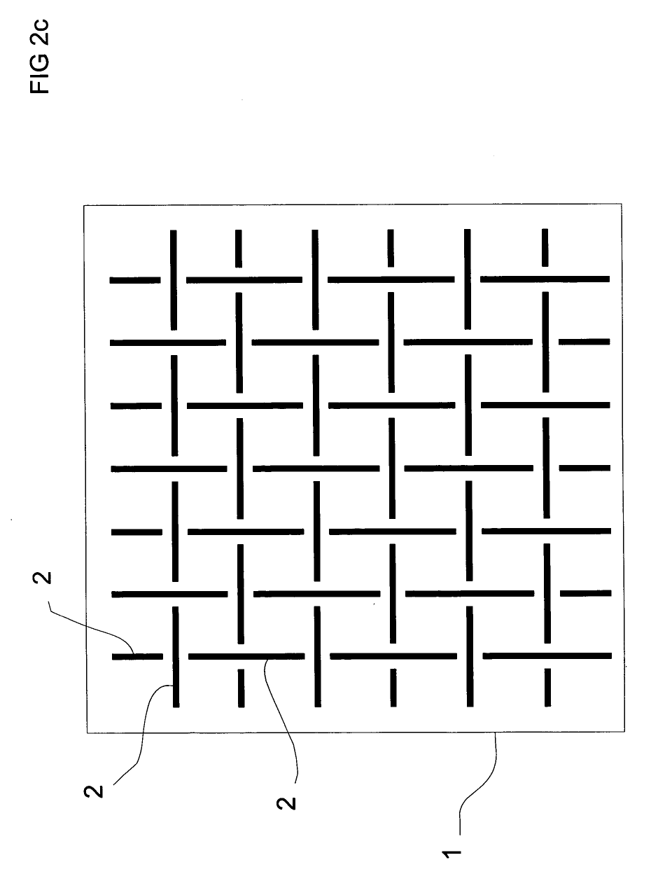

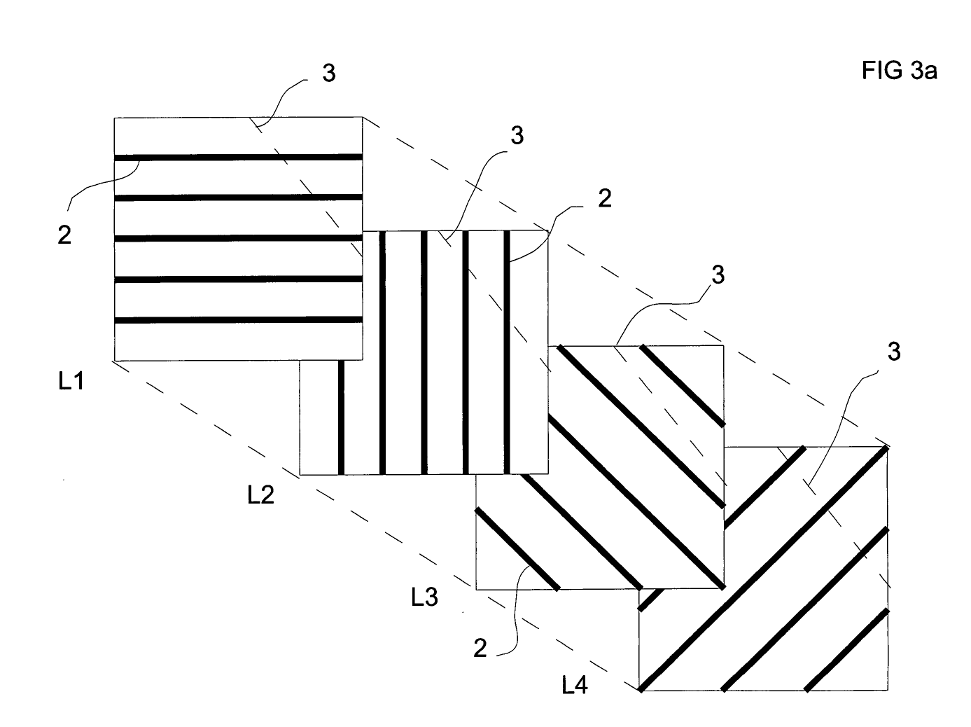

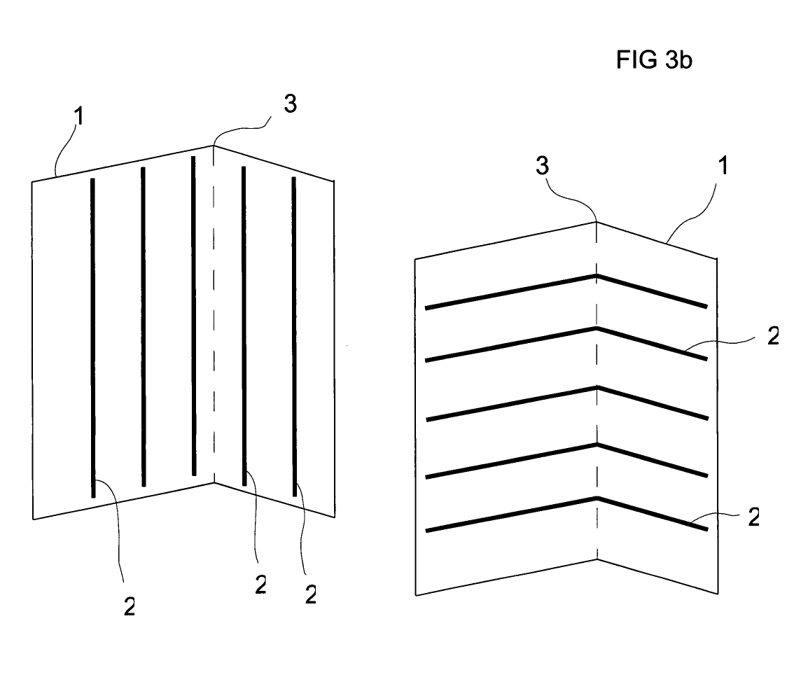

FIGS. 2a, 2b, and 2c show three strategies that may be used in applying strain gauge sensors 2 to the flexible surface of a display in accordance with the present invention. The flexible surface 1 shown in FIG. 2a contains 4 layers of sensors which have been arranged to cover the display from edge to edge. Because the layers are oriented in four different directions and sensors cover the surface to its corners, it is not possible to create a line of bend which does not cause at least one of the bend sensors to be activated. In the flexible display shown in FIG. 2a, FIG. 3a, and FIG. 3b, a vertical bend of the display as shown in FIG. 3b will create a change in the values expressed by some of the diagonal sensors (contained in layers L3 and L4 of FIG. 3a) and all of the horizontal sensors (layer L1), but no change will be registered in the vertical sensors (layer L2). In this way, the sensor layers can be used to determine where a bend is located and how the bend is oriented. Similarly, diagonal bends (of approximately 45 degrees) can be detected at the top right and bottom right corners. In the case of corner bends, some of the vertical sensors and some of the horizontal sensors will be activated as shown in FIG. 3a, but the values of sensors which run parallel to the bend will not change. Alternative embodiments could provide sensors along the periphery of the display as in FIG. 2b or use smaller sensors arranged in a grid or some other pattern as in FIG. 2c. Multiple lines of bend may be detected by the line detector 4 in order to provide additional levels of control. These lines may be detected simultaneously if the sensor arrangement permits, as in the sensor grid shown in FIG. 2c, or a single line of bend may be detected at different times, perhaps as its location or orientation changes. [By looking at how the bend changes from one to the next] In an example embodiment, the output from the line detector 4 is a description of each line detected 3, in terms of position, orientation, and degree of bend. This output can be combined with other sensor values (a touch sensor, for example) to provide additional dimension of control to the display controller 5.

In the above embodiments, a controller 5 uses the output from the line detector 4 to select and modify user interface elements. Such a controller can feature a set logical rules expressed in hardware or software to unambiguously define what action should be performed given a set of input values which describe the bend or bends exhibited by the flexible display. In one example, the following rules are employed: (1) a vertical bend of at least 20 degrees located to the right of the display centerline selects the item at the end of the list; (2) a vertical bend of at least 10 degrees located to the left of the display centerline selects the item at the beginning of the list; (3) a diagonal 20-degree bend forming a diagonal line (approximately 45 degrees) dividing the bottom right corner from the other portions of the display will scroll forward in the list, selecting a subsequent item every second; (4) a diagonal 20-degree bend forming a diagonal line dividing the top right corner from the other portions of the display will scroll back in the list. In this example, the bend readings are processed once every 0.25 seconds. In this embodiment, the degree of bend determines the speed with which the changes to the display may occur. When a bend of between 20 and 60 degrees is detected, changes to the display are processed once per second. If a bend is greater than 60 degrees is detected, changes to the display will be processed two times per second.

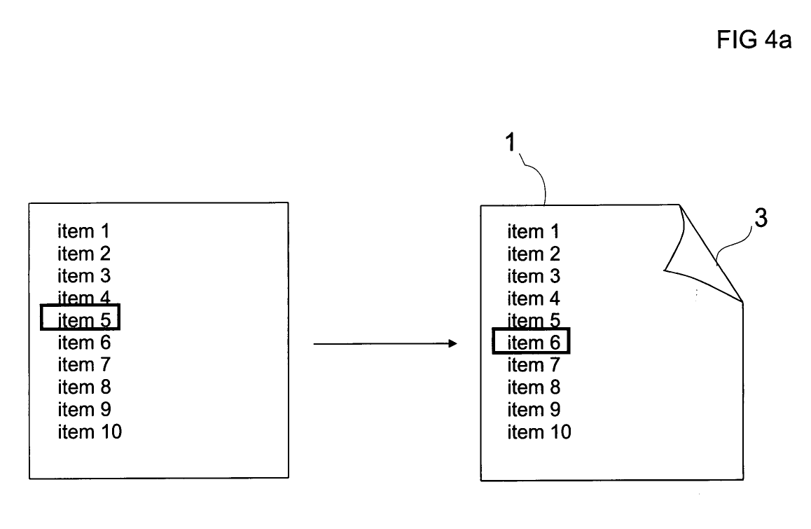

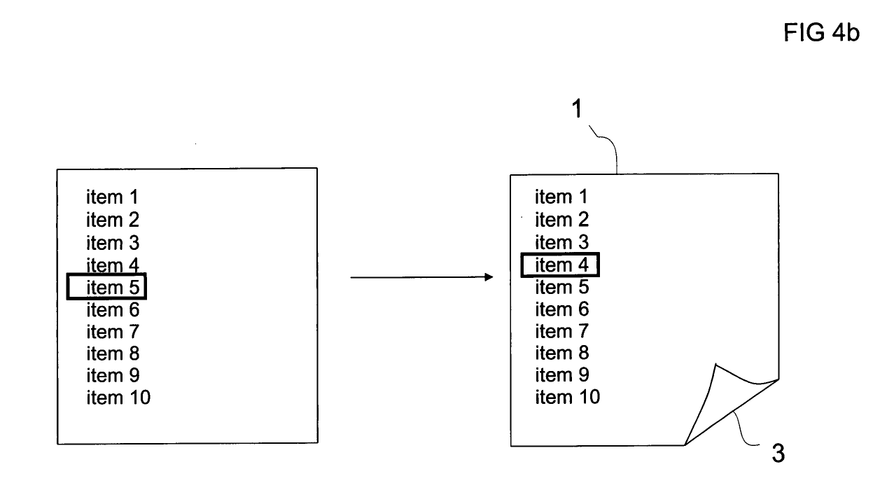

FIGS. 4a and 4b show the operation of the display described above before and after the user bends the display to select previous and subsequent items from a list. According to the above embodiment, in FIG. 4a, a bend 3 at the top right corner of the flexible surface 1 of the display causes the controller 5 to select the subsequent item in the list. The image 6 is updated accordingly. FIG. 4b shows a bend 3 at the bottom right of the display, which causes a previous item to be selected. A vertical bend as shown in FIG. 3b would select the very first or very last item in the list, depending on whether the vertical bend was to the left or the right of the display's center.

While changes and variations to the embodiments may be made by those skilled in the display field, the scope of the invention is to be determined by the appended claims.

What is claimed is:

1. A display comprising:
(a) a flexible surface operable to exhibit images, said flexible surface being capable of exhibiting variable degrees of bend;
(b) a plurality of bend sensors for creating a plurality of bend measurements from a line of bend; and
(c) a line detection device operable to detect orientation and position of said line of bend based on said plurality of bend measurements.

2. A display as recited in claim 1, wherein at least one of said bend sensors comprises a strain gauge.

3. A display as recited in claim 2, wherein said strain gauge comprises a peizo-electric bimorph.

4. A display as recited in claim 2, wherein said strain gauge comprises a fiber optic curvature sensor.

5. A display as recited in claim 1, wherein said bend sensors are located along the edges of said display.

6. A display as recited in claim 1, wherein said bend sensors form layers of said flexible surface.

7. A display as recited in claim 1, wherein said line detection device is operable to detect the degree of bend of said line of bend.

8. A display as recited in claim 1, wherein said flexible surface comprises at least one organic light emitting diode.

9. A display as recited in claim 1, wherein said flexible surface comprises at least one liquid crystal display element.

10. A display as recited in claim 1, wherein said display comprises multiple flexible surfaces, each operable to exhibit images.

11. A display as recited in claim 1, said display further comprising a controller operable, when activated, to manipulate an element of said image, said line detecting device being operable to activate said controller.

12. A display as recited in claim 11, wherein said element of said image comprises a scroll bar.

13. A method of controlling the information presented on a display, said display comprising: (1) a flexible surface operable to exhibit images, said flexible surface being capable of exhibiting variable degrees of bend; (2) a plurality of bend sensors for creating a plurality of bend measurements from a line of bend; and (3) a line detection device operable to detect orientation and position of said line of bend based on said plurality of bend measurements, said method comprising the steps of:
(a) obtaining the orientation and position of a line of bend present on said flexible surface; and
(b) making a change to the information displayed by said display in response to the orientation and position of said line of bend present on said flexible surface.

14. A method of controlling the information presented on a display as set forth in claim 13, wherein said line of bend orientation and position are used to control at least one graphical user interface element.

15. A method of controlling the information presented on a display as set forth in claim 14, wherein said graphical user interface element is a scroll bar.

16. A method of controlling the information presented on a display as set forth in claim 14, wherein said graphical user interface element is a cursor.

17. A method of controlling the information presented on a display as set forth in claim 13, wherein:
(a) said step of obtaining the orientation and position of a line of bend present on said flexible surface is performed twice in order to obtain a first position, a first orientation, a second position, and a second orientation; and
(b) said step of making a change to the information displayed by said display in response to line of bend position, orientation, and changes thereto as determined by computing the difference between first and second values.

18. A method for controlling a display comprising a first line of bend, said method comprising:
(a) creating a first position measurement of the position of said first line of bend;
(b) creating a first orientation measurement of the orientation of said first line of bend; and
(c) changing the information represented on said display based on the combination of at least said first position measurement and said first orientation measurement.

19. A method as recited in claim 18, further comprising mapping a combination of at least said first position measurement and said first orientation measurement to a controller function.

20. A method as recited in claim 18, further comprising:
(a) creating a second position measurement of a second line of bend;
(b) creating a second orientation measurement of a second line of bend; and
(c) mapping a combination of at least said first position measurement, said second position measurement, said first orientation measurement, and said second orientation measurement to a controller function.
